(19) United States
(12) Patent Application Publication
(10) Pub. No.: US 2014/0132165 A1
(43) Pub. Date: May 15, 2014

(54) Light Emitting Device Array Billboard and Row Switch Circuit and Control Method Thereof

(71) Applicants: Shui-Mu Lin, Taichung (TW); Ching-Yu Chen, Guanxi Township (TW); Chien-Hua Lin, Xiushui Township (TW); Ti-Ti Liu, Taipei (TW); Kuan-Cheng Lai, Zhubei City (TW)

(72) Inventors: Shui-Mu Lin, Taichung (TW); Ching-Yu Chen, Guanxi Township (TW); Chien-Hua Lin, Xiushui Township (TW); Ti-Ti Liu, Taipei (TW); Kuan-Cheng Lai, Zhubei City (TW)

(73) Assignee: RICHTEK TECHNOLOGY CORPORATION, R.O.C, Zhubei City (TW)

(21) Appl. No.: 14/069,772

(22) Filed: Nov. 1, 2013

Related U.S. Application Data
(60) Provisional application No. 61/726,648, filed on Nov. 15, 2012.

(51) Int. Cl. H05B 33/08

(52) U.S. Cl. CPC H05B 33/083; H05B 33/0827
USPC 315/192

(57) ABSTRACT

The present invention discloses a light emitting device array billboard and a row switch circuit and a control method thereof. The light emitting device array billboard includes a light emitting device array circuit, plural row switch circuits, plural column driver circuits, and a control circuit. The light emitting device array circuit includes plural light emitting devices arranged by columns and rows. Each row switch circuit determines whether to electrically connect a row conduction voltage to the corresponding row node or to discharge charges at the corresponding row node through a discharging path according to a row selection signal. Each column driver circuit determines whether or not to electrically connect a column conduction voltage to the corresponding column node according to a column selection signal. The control circuit provides the row selection signal and the column selection signal to the row switch circuits and the column driver circuits.

### CROSS REFERENCE

The present invention claims priority to U.S. 61/726648, filed on Nov. 15, 2012.

### BACKGROUND OF THE INVENTION

1. Field of Invention

The present invention relates to a light emitting device array billboard and a row switch circuit and a control method thereof; particularly, it relates to such light emitting device array billboard and row switch circuit and control method thereof which are capable of eliminating ghost images.

2. Description of Related Art

FIG. 1A shows a schematic diagram of a prior art light emitting diode (LED) array billboard 100. As shown in FIG. 1A, the LED array billboard 100 includes an LED array circuit 110, plural row switch circuits 120, and plural column driver circuits 130. The LED array circuit 110 includes plural LEDs which are arranged in an array with plural rows and plural columns. During normal operation of the LED array billboard 100, an image frame is scanned row by row, wherein a conduction voltage Vdd is electrically connected to the rows in turn, that is, the rows sequentially receive the conduction voltage Vdd and before a next row starts receiving the conduction voltage Vdd, a previous row stops receiving the conduction voltage Vdd. On the other hand, a predetermined low level is electrically connected to one or more selected columns at proper timings, such that one or more selected LEDs are turned ON and therefore a predetermined image pattern is displayed. For example, as shown in FIG. 1A, for turning ON the LED at a position of coordinates (N, M), which is the position at the Nth row and Mth column (hereinafter row N and column M) in the array, the row switch circuit 120 of the row N is controlled by the row selection signal to turn ON a P-type metal oxide semiconductor (PMOS) device therein, whereby the conduction voltage Vdd is electrically connected to the row N, and meanwhile, the column driver circuit 130 of the column M is controlled by the column selection signal to electrically connect the predetermined low level to the column M, such that a conduction current flows through the LED at the coordinates (N, M) to turn ON the LED.

A ghost image problem may happen during the aforementioned normal operation. The ghost image may be an upper ghost image or a lower ghost image. FIG. 1B shows a typical test for the LED array billboard 100. In the test, LEDs on a diagonal of the array are turned ON (indicated by white circles in the figure) to test whether the LED array billboard 100 operates normally. It is often found during the test that the LEDs above the diagonal of the array (indicated by grey circles in the figure) are turned ON dimly, which is called the upper ghost image. The phenomenon of the upper ghost image occurs because of a parasitic capacitor CR in the row switch circuit 120. Referring to FIG. 1A, for example in the aforementioned test, the row switch circuits 120 corresponding to the row N−1 and the row N electrically connect the conduction voltage Vdd to the row N−1 and the row N sequentially according to the row selection signal, and correspondingly, the column driver circuits 130 corresponding to the column M+1 and the column M electrically connect the low voltage to the column M+1 and the column M sequentially according to the column selection signal, such that the two LEDs at the coordinates (N−1, M+1) and (N, M) are turned ON sequentially. When the row switch circuit 120 of the row N−1 stops supplying the conduction voltage Vdd to the row N−1, there still are residue charges stored in the parasitic capacitor CR of the row switch circuit 120 of the row N−1, such that when the column driver circuit 130 of the column M electrically connect the low voltage to the column M, these residue charges release through a discharging path as indicated in the figure, which turn ON the LED at coordinates (N−1, M) to generate the upper ghost image as indicated by the dashed circle shown in FIG. 1B.

Referring to FIG. 1D, in the aforementioned test, it is also often found that the LEDs below the diagonal of the array (indicated by grey circles in the figure) are turned ON dimly, which is called the lower ghost image. The phenomenon of the lower ghost image occurs because of a parasitic capacitor CC in the column driver circuit 130. Referring to FIGS. 1C and 1D, for example in the aforementioned test, the row switch circuits 120 corresponding to the row N and the row N+1 electrically connect the conduction voltage Vdd to the row N−1 and the row N sequentially according to the row selection signal, and correspondingly, the column driver circuits 130 corresponding to the column M and the column M−1 electrically connect the low voltage to the column M and the column M−1 sequentially according to the column selection signal, such that the two LEDs at the coordinates (N, M) and (N+1, M−1) are turned ON sequentially. When the column driver circuit 130 stops supplying the low voltage to the column M, because of the parasitic capacitor CC in the column driver circuit 130 of the column M, when the conduction voltage Vdd is electrically connected to the row N+1, a charging path is formed which conducts a current from the row switch circuit 120 of the row N+1, via the LED at the coordinates (N+1, M), to the parasitic capacitor CC of the column driver circuit 130 as indicated in FIG. 1C, such that the LED at coordinates (N+1, M) is turned ON slightly during the charging process to generate the lower ghost image as indicated by the dashed circle shown in FIG. 1D.

FIG. 2 shows a prior art LED array billboard 200 which intends to solve the aforementioned upper ghost image problem. As shown in FIG. 2, the LED array billboard 200 is different from the LED array billboard 100 in that each row switch circuit 220 further includes a resistor RR besides the PMOS device, which is electrically connected between the PMOS device and a ground level to provide a discharging path, such that the charges stored in the parasitic capacitor CR can be released through the resistor RR to ground after the row switch circuit 220 stops electrically connecting the conduction voltage Vdd to the row, and therefore the LED of the row is not turned ON by the residue charges in the parasitic capacitor CR.

One of the drawbacks of the prior art LED array billboard 200 is that it has a problem when one LED is shorted. As shown in FIG. 2, for example when the LED at the coordinates (N, M) is shorted, i.e., its forward terminal and reverse terminal are short-circuited, the column M is short-circuited to the row N. After the row switch circuit 220 of the row N stops electrically connecting the conduction voltage Vdd to the row N, the voltage of the row N drops to a low level, whereby the reverse terminals of all the LEDs at the column M also drop to the low level. Therefore, when any row switch circuit 220 electrically connects the conduction voltage Vdd to the corresponding row, the LED of the column M in that row is also turned ON, and thus in one image frame, i.e., in the process of row-by-row scanning, except the shorted LED at the coordinates (N, M), all LEDs of the column M will be turned ON, which is called a “tear”. The conduction current paths of the tear are indicated by the arrows shown in FIG. 2.

In view of above, the present invention proposes a light emitting device array billboard and row switch circuit and control method thereof which are capable of eliminating ghost images and other problems.

### SUMMARY OF THE INVENTION

From one perspective, the present invention provides a light emitting device array billboard, including: a light emitting device array circuit including a plurality of light emitting devices, which are arranged in an array with a plurality of rows and a plurality of columns, wherein forward terminals of the light emitting devices in each row are commonly coupled to a row node, and reverse terminals of the light emitting devices in each column are commonly coupled to a column node; a plurality of row switch circuits, which are coupled to the row nodes respectively, wherein each row switch circuit determines whether to electrically connect a corresponding row conduction voltage to the corresponding row node or to discharge charges at the corresponding row node through a discharging path according to a row selection signal; a plurality of column driver circuits, which are coupled to the column nodes respectively, wherein each column driver circuit determines whether or not to electrically connect a corresponding column conduction voltage to the corresponding column node according to a column selection signal; and a control circuit, which is coupled to the row switch circuits and the column driver circuits, for providing the row selection signal and the column selection signal to the row switch circuits and the column driver circuits respectively.

In one preferable embodiment, the row switch circuit includes: a first switch device, which is coupled to the corresponding row node, for electrically connecting the corresponding row conduction voltage to the corresponding row node according to the row selection signal; and a second switch device, which is coupled to the corresponding row node, for electrically connecting the corresponding row node to a ground level or a predetermined low level to form the discharging path according to the row selection signal such that the charges are discharged through the discharging path.

In the aforementioned embodiment, the first switch device preferably includes a P-type metal oxide semiconductor (PMOS) device, and the second switch device includes an N-type metal oxide semiconductor (NMOS) device.

In one preferable embodiment, the column driver circuit electrically connects a predetermined high level to the corresponding column node when the column driver circuit determines not to electrically connect the column conduction voltage to the corresponding column node, and the column driver circuit includes: a driver device, which is coupled to the corresponding column node, for generating the corresponding column conduction voltage according to the column selection signal; and a switch device, which is coupled to the corresponding column node, for electrically connecting the predetermined high level to the corresponding column node according to the column selection signal.

In one preferable embodiment, the predetermined high level is higher than the corresponding row conduction voltage minus a conduction voltage of the light emitting device.

In one preferable embodiment, the second switch device keeps electrically connecting the corresponding row node to the ground level or the predetermined low level to form the discharge path until or after another row switch circuit electrically connects the corresponding row conduction voltage to another row node.

From another perspective, the present invention provides a row switch circuit for use in a light emitting device array billboard, wherein the light emitting device array billboard includes a light emitting device array circuit, a plurality of the row switch circuits, a plurality of column driver circuits, and a control circuit, and wherein the light emitting device array circuit includes a plurality of light emitting devices, which are arranged in an array with a plurality of rows and a plurality of columns, wherein forward terminals of the light emitting devices in each row are commonly coupled to a row node, and reverse terminals of the light emitting devices in each column are commonly coupled to a column node, wherein the row nodes are coupled to the row switch circuits respectively, and the column nodes are coupled to the column driver circuits respectively, and the control circuit generates a row selection signal and a column selection signal for controlling the row switch circuits and the column driver circuits, the row switch circuit comprising: a first switch device, which is coupled to a corresponding row node, for electrically connecting a corresponding row conduction voltage to the corresponding row node according to the row selection signal; and a second switch device, which is coupled to the corresponding row node, for discharging charges at the corresponding row node through a discharging path to a ground level or a predetermined low level according to the row selection signal.

From another perspective, the present invention provides a control method for controlling a light emitting device array billboard, wherein the light emitting device array billboard has a light emitting device array circuit including a plurality of light emitting devices arranged in an array with a plurality of rows and a plurality of columns, wherein forward terminals of the light emitting devices in each row are commonly coupled to a row node, and reverse terminals of the light emitting devices in each column are commonly coupled to a column node, the control method comprising: selecting at least one row and at least one column; electrically connecting a first row conduction voltage to the row node of the selected row; electrically connecting a column conduction voltage to the column node of the selected column; conducting a discharging path electrically connected with the row node of the selected row to discharge charges at the row node of the selected row, wherein the discharging path does not go through the light emitting devices; and stopping conducting the discharging path electrically connected with the row node of the selected row.

In one preferable embodiment, the control method further includes: electrically connecting the column node of the selected column to a predetermined high level after electrically connecting the column conduction voltage to the column node of the selected column, wherein the predetermined high level is preferably higher than the first row conduction voltage minus a conduction voltage of the light emitting device.

In one preferable embodiment, the control method further includes: selecting another row after the step of conducting the discharging path electrically connected with the row node of the selected row; and electrically connecting a second row conduction voltage to the row node of the selected another row, wherein the second conduction voltage is the same or different from the first conduction voltage, and wherein the step of stopping conducting the discharging path electrically connected with the row node of the selected row takes place after the row node of the selected another row is electrically connected to the second row conduction voltage.

The objectives, technical details, features, and effects of the present invention will be better understood with regard to the detailed description of the embodiments below.

### BRIEF DESCRIPTION OF THE DRAWINGS

FIG. 1A shows a schematic diagram of a prior art light emitting diode (LED) array billboard 100.

FIG. 1B shows a typical test for the LED array billboard 100 and an upper ghost image.

FIGS. 1C and 1D show schematic diagrams of a lower ghost image of the LED array billboard 100.

FIG. 2 shows a schematic diagram of a prior art LED array billboard 200.

FIG. 3 shows a first embodiment the present invention.

FIG. 4 shows a second embodiment of the present invention.

FIGS. 5A and 5B show a third embodiment of the present invention.

FIGS. 6A and 6B show a fourth embodiment of the present invention.

FIG. 7 shows a fifth embodiment of the present invention.

FIG. 8 shows a sixth embodiment of the present invention.

FIG. 9 shows a seventh embodiment of the present invention.

### DESCRIPTION OF THE PREFERRED EMBODIMENTS

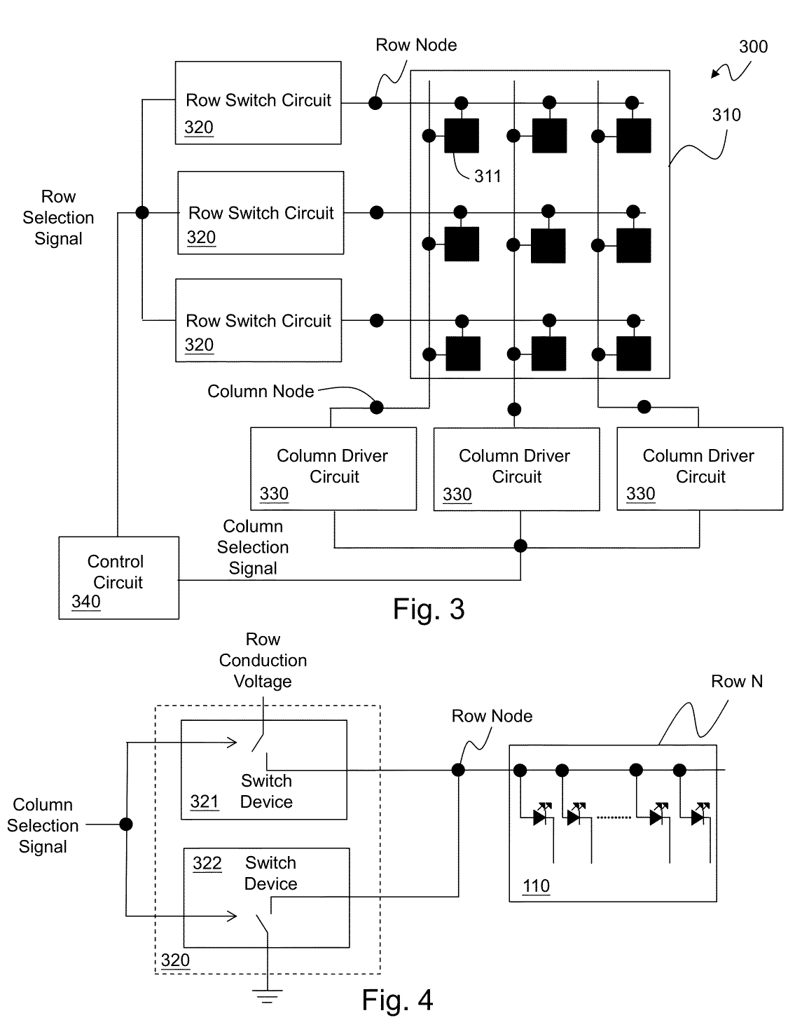

Please refer to FIG. 3 for a first embodiment according to the present invention. As shown in FIG. 3, a light emitting device array billboard 300 includes a light emitting device array circuit 310, plural row switch circuits 320, plural column driver circuits 330, and a control circuit 340. The light emitting device array circuit 310 includes plural light emitting devices 311, which are arranged in an array with plural rows and plural columns, wherein forward terminals of the light emitting devices 311 in each row are commonly coupled to a row node, and reverse terminals of the light emitting devices 311 in each column are commonly coupled to a column node. The plural row switch circuits 320 are coupled to the row nodes respectively, wherein each row switch circuit 320 determines whether to electrically connect a row conduction voltage to the corresponding row node or to discharge charges at the corresponding row node through a discharging path (not shown, but will be described in details later) according to a row selection signal. The row conduction voltage is for example but not limited to a typical power supply level such as 5V. The row conduction voltage of one row may be the same as or different from the row conduction voltage of another row. After a row switch circuit 320 stops electrically connecting the row conduction voltage to its corresponding row node, the discharging path decreases the voltage level of the corresponding row node to solve the upper ghost image problem. The plural column driver circuits 330 are coupled to the column nodes respectively, wherein each column driver circuit 330 determines whether or not to electrically connect a column conduction voltage to the corresponding column node according to a column selection signal. The column conduction voltage is for example but not limited to a voltage which is lower than the row conduction voltage minus a conduction voltage of the light emitting device 311 (i.e., Vcon<Vron−Vf, wherein Vcon is the column conduction voltage; Vron is the row conduction voltage; and the Vf is the conduction voltage of the light emitting device 311), such that the light emitting device 311 is turned ON when the corresponding column driver circuit 330 connects the column conduction voltage to the corresponding column node, and the corresponding row switch circuit 320 connects the row conduction voltage to the corresponding row node. The column conduction voltage of one column may be the same as or different from the column conduction voltage of another column. When the column driver circuit 330 determines not to electrically connect the column conduction voltage to the corresponding column node, preferably, it may determine to electrically connect a predetermined high level to the corresponding column node. The predetermined high level is for example higher than the row conduction voltage minus the conduction voltage of the light emitting device 311 (i.e., Vp>Vron−Vf, wherein Vp is the predetermined high level; Vron is the row conduction voltage; and Vf is the conduction voltage of the light emitting device 311), such that when the corresponding column driver circuit 330 connects the predetermined high level to the corresponding column node, the light emitting devices in this column will not be turned ON to solve the lower ghost image problem.

The control circuit 340 is coupled to the row switch circuits 320 and the column driver circuits 330, for providing the row selection signal and the column selection signal to the row switch circuits 320 and the column driver circuits 330 respectively. In one embodiment, for example, the row selection signal generated by the control circuit 340 selects the rows sequentially in a scanning form (row by row, one single row at a time), and the column selection signal generated by the control circuit 340 selects one or more columns according to a predetermined image pattern (may be plural columns at a time) . The light emitting device 311 is for example but not limited to a light emitting diode (LED) device.

FIG. 4 shows a second embodiment of the present invention. This embodiment shows a more specific embodiment of the row switch circuit 320 in the first embodiment. As shown in FIG. 4, the row switch circuit 320 includes a switch device 321 and a switch device 322. The switch device 321 is coupled to the corresponding row node, for electrically connecting the row conduction voltage to the corresponding row node according to the row selection signal. The switch device 322 is coupled to the corresponding row node, for electrically connecting the corresponding row node to the ground level or a predetermined low level according to the row selection signal, to discharge charges at the corresponding row node through the discharging path to the ground level or the predetermined low level. In this embodiment, the switch device 321 is controlled by for example but not limited to the row selection signal, such that when the switch device 321 is turned ON by the row selection signal, the corresponding row node is electrically connected to the row conduction voltage, whereby the forward terminals of the LEDs of the corresponding row are electrically connected to the row conduction voltage. When a reverse terminal of any LED of the corresponding row is electrically connected to a voltage which is lower than the row connection voltage minus the conduction voltage of the LED, the LED is turned ON. The switch device 322 is controlled by for example but not limited to the row selection signal, such that when the switch device 322 is turned ON by the row selection signal, the corresponding row node is electrically connected to for example but not limited to the ground level (or a predetermined low level), whereby the forward terminals of the LEDs of the corresponding row are electrically connected to the ground level or the predetermined low level to solve the upper ghost image problem by lowering the level of the row node.

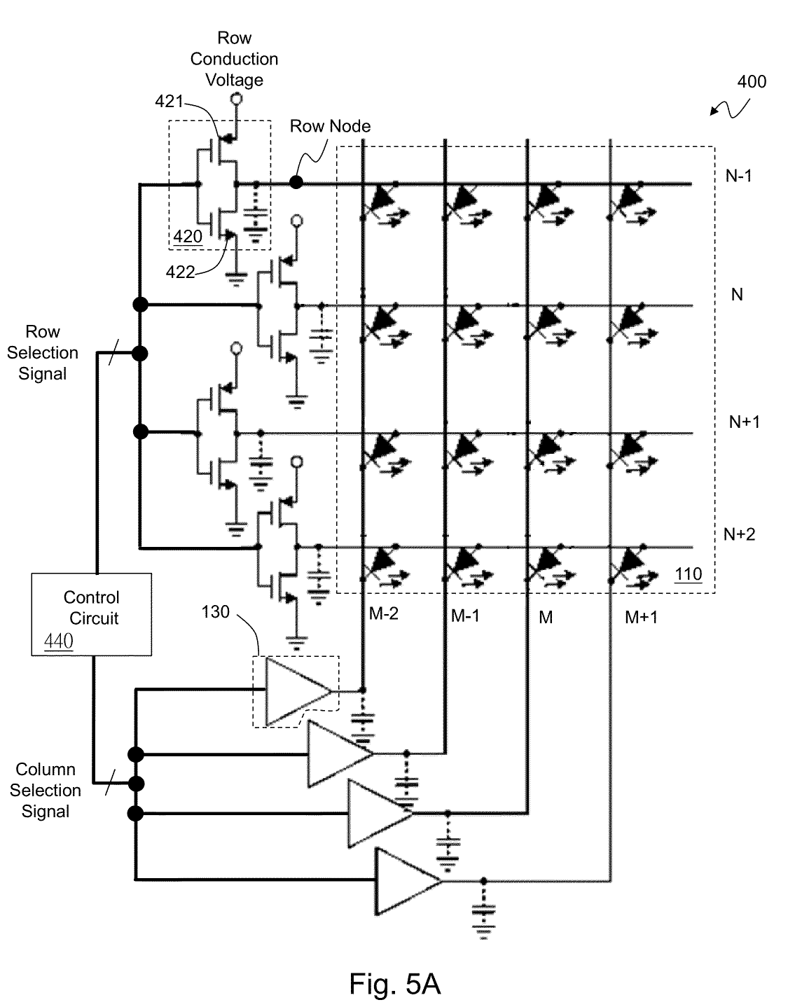

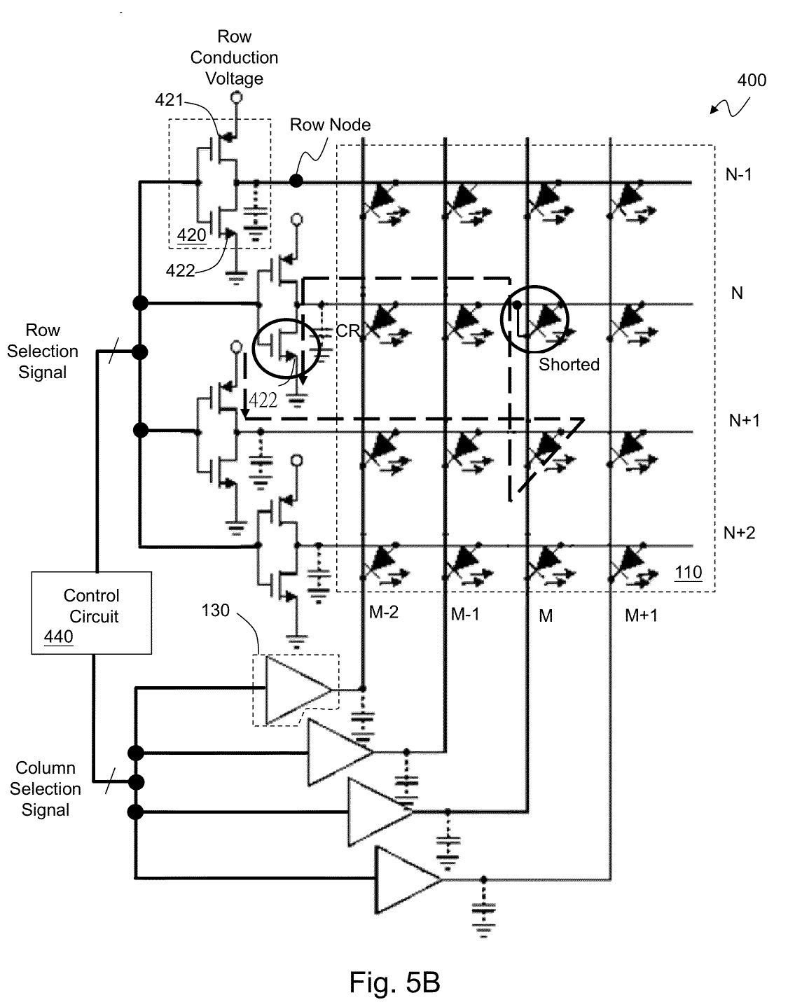

FIGS. 5A and 5B show a third embodiment of the present invention. This embodiment shows a specific embodiment of the LED array billboard 400. As shown in FIG. 5A, the LED array billboard 400 includes the LED array circuit 110, plural row switch circuits 420, plural column driver circuits 130, and a control circuit 440. Besides the control circuit 440, this embodiment is different from the prior art LED array billboard 100 in the row switch circuit 420. In this embodiment, the row switch circuit 420 includes a P-type metal oxide semiconductor (PMOS) device 421, and an N-type metal oxide semiconductor (NMOS) device 422. Drains of the PMOS device 421 and the NMOS device 422 are commonly coupled to the corresponding row node. Gates of the PMOS device 421 and the NMOS device 422 are commonly coupled to the control circuit 440 for receiving the row selection signal. A source of the PMOS device 421 receives the row conduction voltage, and a source of the NMOS device 422 is electrically connected to the ground level (or the predetermined low level). When the PMOS device 421 is turned ON, the row conduction voltage is electrically connected to the corresponding row node, and when the NMOS device 422 is turned ON, the corresponding row node is electrically connected to the ground level (or the predetermined low level) for discharging charges at the corresponding row node through a discharging path to the ground level (or the predetermined low level) to solve the upper ghost image problem.

FIG. 5B shows how the third embodiment of the present invention solves the tear problem. Let us assume that the LED at coordinates (N, M) in the LED array circuit 110 is shorted. According to the present invention, after the row switch circuit 420 of any row stops electrically connecting the row conduction voltage to the corresponding row node, the NMOS device 422 of the row switch circuit 420 is turned ON to discharge the charges in the parasitic capacitor CR, and thereafter the NMOS device 422 is turned OFF. Next, the row switch circuit 420 corresponding to a next row starts electrically connecting the row conduction voltage to the row node of the next row. In the embodiment shown in FIG. 5B, after the row switch circuit 420 of the row N stops electrically connecting the row conduction voltage to the corresponding row node, the NMOS device 422 of the row switch circuit 420 of the row N is turned ON to discharge the charges in the parasitic capacitor CR, to solve the upper ghost image problem. Next, the NMOS device 422 of the row switch circuit 420 of the row N is turned OFF. Next, the row switch circuit 420 of the row N+1 starts electrically connecting the row conduction voltage to the row node of the row N+1. When the row switch circuit 420 of the row N+1 starts electrically connecting the row connection voltage to the row node of the row N+1, because the NMOS device 422 corresponding to the row N is turned OFF, there is no conduction path from the reverse terminal of any of the LEDs in column M to the ground level (or the predetermined low level), so the tear problem is solved because the conduction path (indicated by the arrows shown in FIG. 5B) does not exist.

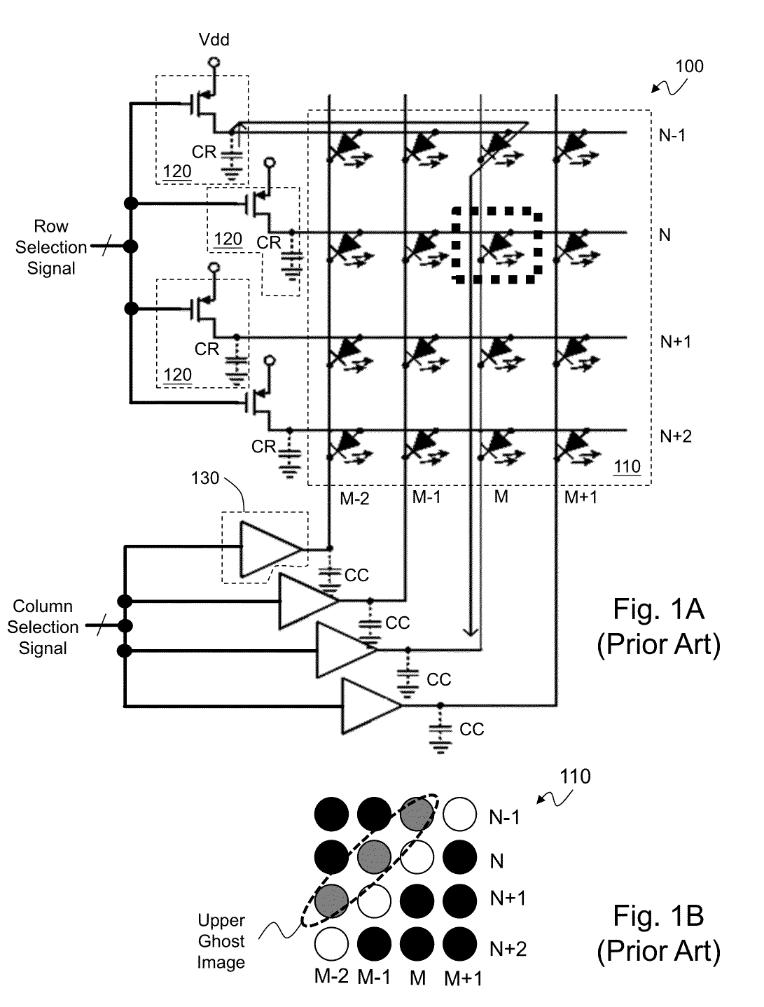

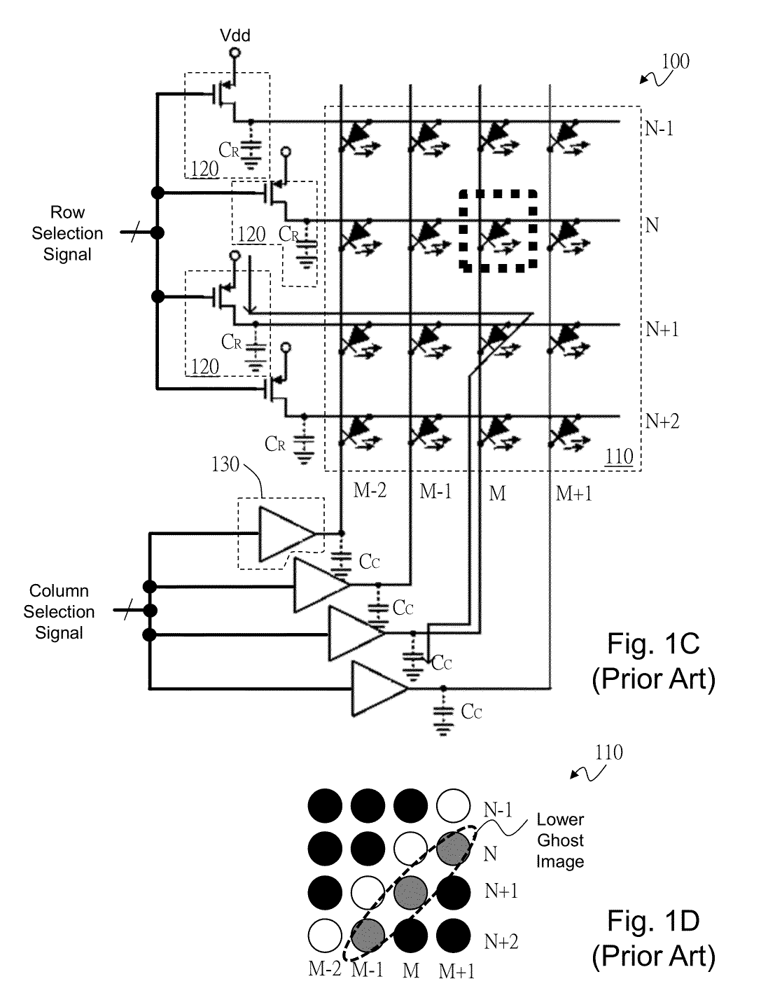

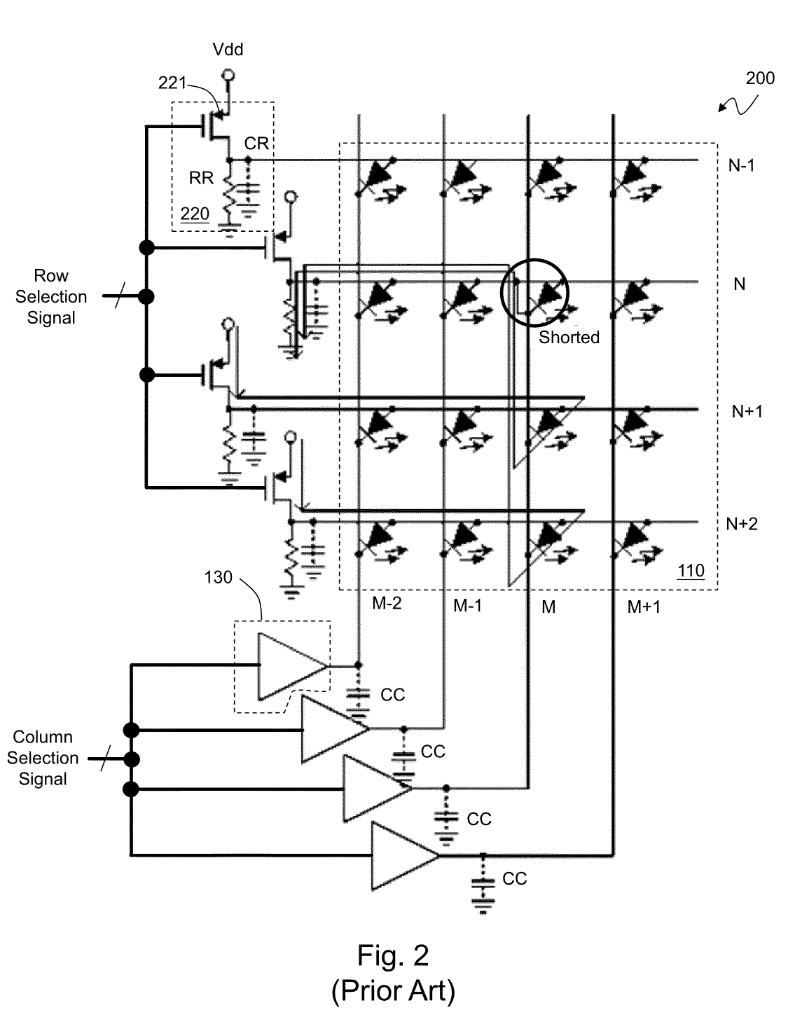

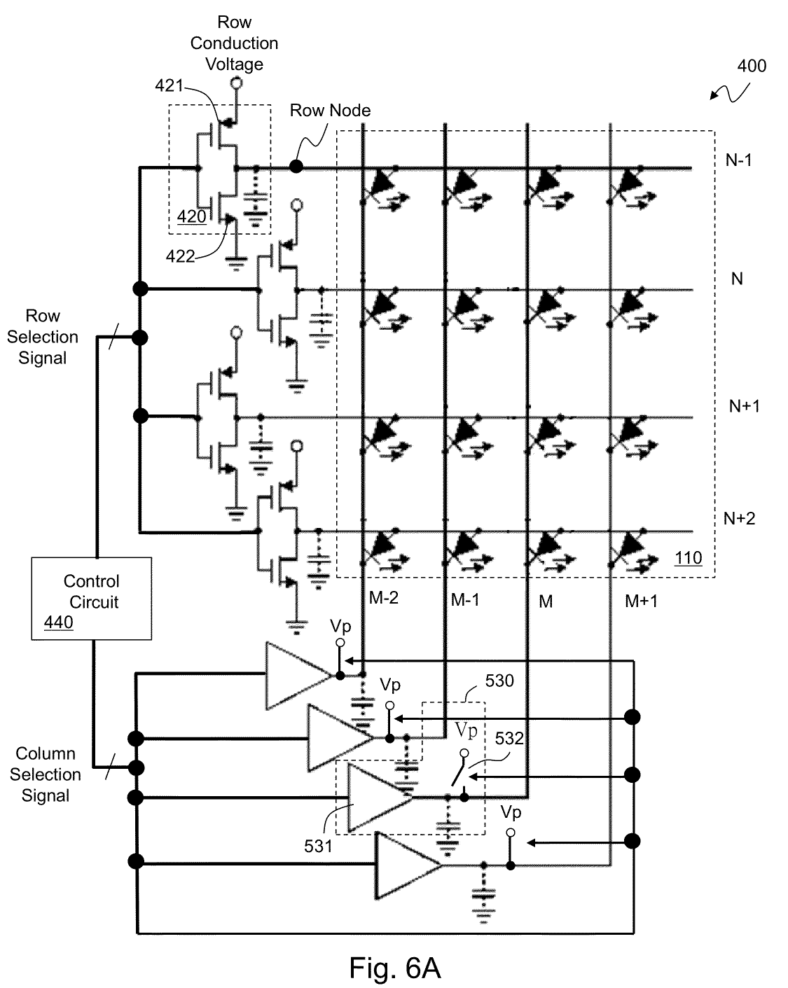

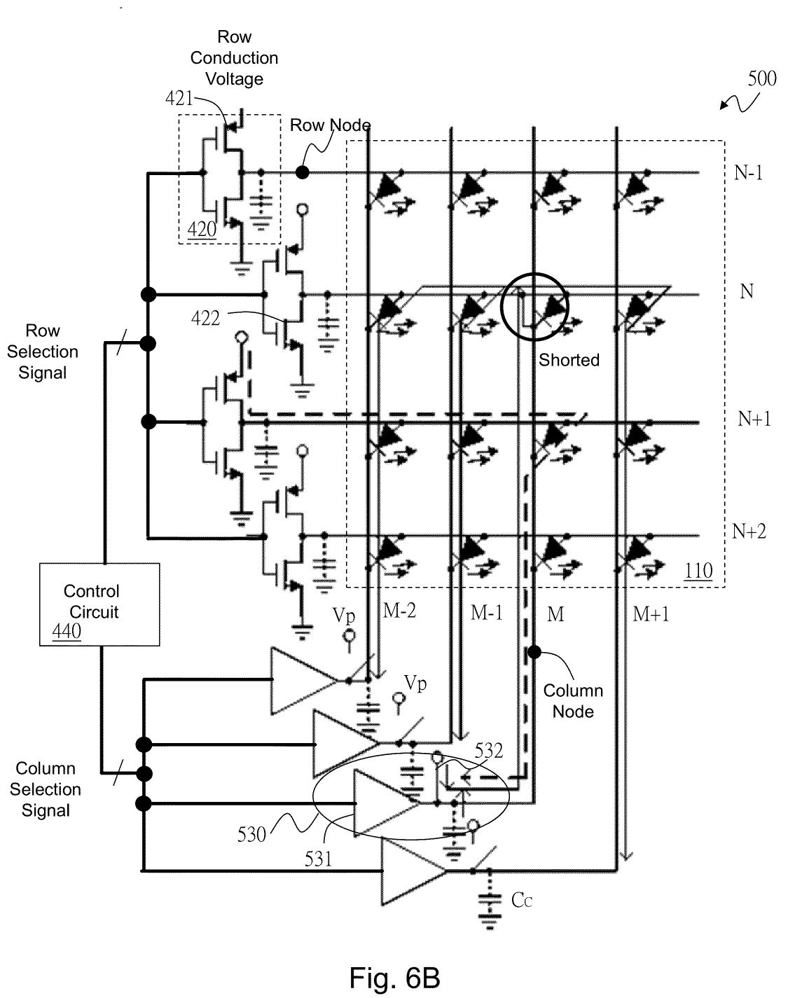

FIGS. 6A and 6B show a fourth embodiment of the present invention. This embodiment shows a more specific embodiment of the LED array billboard 500. This embodiment is different from the third embodiment in that, each column driver circuit 530 of the LED array billboard 500 in this embodiment includes a driver device 531 and a switch device 532. The driver device 531 is coupled to the corresponding column node, for generating the column conduction voltage according to the column selection signal to turn ON a selected LED. The switch device 532 is coupled to the corresponding column node, for electrically connecting a predetermined high level Vp to the corresponding column node. For example, as shown in FIG. 6A, when the driver device 531 corresponding to the column M electrically connects the column conduction voltage to the column node of the column M, the switch device 532 is OFF and not electrically connecting the predetermined high level Vp to the column node of the column M. The other driver circuits 531 corresponding to the other columns do not electrically connect the column conduction voltage to the corresponding column nodes, and the switch devices 532 corresponding to these columns are ON to electrically connect the predetermined high level Vp to the corresponding column nodes, to solve the lower ghost image problem. The predetermined high level Vp is for example higher than the row conduction voltage minus the conduction voltage of the light emitting device 311 (i.e., Vp>Vron−Vf, wherein Vp is the predetermined high level; Vron is the row conduction voltage; and Vf is the conduction voltage of the light emitting device 311). For example, when the row conduction voltage is 5V, the predetermined high level Vp may be for example but not limited to 3V or higher. When the column node is electrically connected to the predetermined high level Vp, referring to FIG. 1C, because the charging path of the parasitic capacitor CC is disconnected, the lower ghost image problem can be solved. When the LED at the corresponding column needs to be turned ON (i.e., the column conduction voltage needs to be electrically connected to the column node), the switch device 532 may be turned OFF and the column node can be electrically connected to the column conduction voltage immediately.

FIG. 6B shows another problem of the prior art LED array billboard because of the shorted LED, and how to solve the problem according to the present invention. When the LED at the coordinates (N, M) is shorted, i.e., a forward terminal and a reverse terminal of the LED are short-circuited, the column node of the column M is short-circuited to the row node of the row N. When the switch device 532 corresponding to the column M is turned ON such that the column node of the column M is electrically connected to the predetermined high level Vp, because the LED at the coordinates (N, M) is shorted and the column node of the column M is short-circuited to the row node of the row N, the level of the row node of row N is pulled up to the predetermined high level Vp. If any switch device 532 of any other column is OFF such that the corresponding column node is at a relatively lower level, a current path may be formed from the row node of the row N to the column node at the relatively lower level, as indicated by the solid arrows shown in FIG. 6B. A solution to this problem is to properly determine the predetermined high level Vp, such that a voltage difference between the parasitic capacitor CC and the predetermined high level Vp is lower than the conduction voltage of the LED.

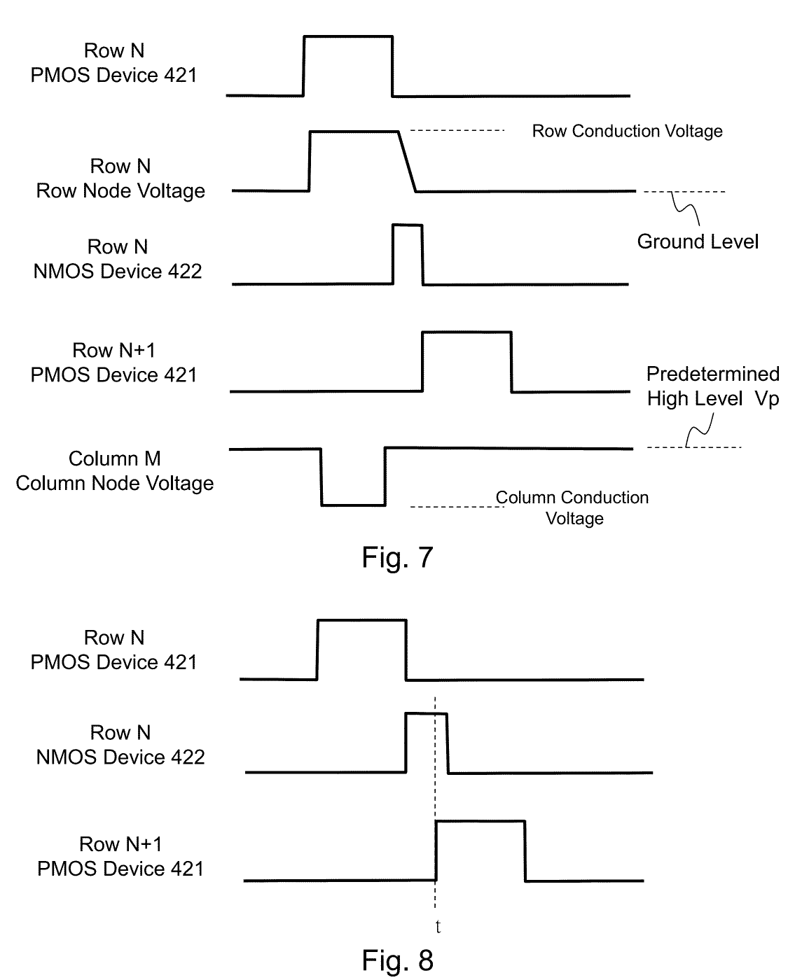

FIG. 7 shows a fifth embodiment of the present invention. This embodiment shows an example of a control method for controlling the LED array billboard 500 in the fourth embodiment. As shown in FIG. 7, first, at least one row and at least one column are selected. For example, the LED at coordinates (N, M) is selected to be turned ON, and a corresponding row selection signal and a corresponding column selection signal is provided. Next, The row selection signal turns ON the PMOS device 421 corresponding to the row N to provide the row conduction voltage to the row node of the row N, and the column node of the column M is electrically connected to the column conduction voltage according to the column selection signal, such that a current path is formed from the row node of the row N, through the LED at the coordinates (N, M), to the column node of the column M, whereby the LED at coordinates (N, M) is turned ON. To turn OFF the LED at coordinates (N, M), first, the column node of the column M is electrically connected to the predetermined high level Vp according to the column selection signal (for solving the lower ghost image problem). Next, the NMOS device 422 corresponding to the row N is turned ON according to the row selection signal, such that the charges at the row node of the row N are discharged to for example but not limited to the ground level through a discharging path formed by the NMOS device 422 (for solving the upper ghost image problem). Next, the NMOS device 422 corresponding to the row N is turned OFF to disconnect the discharging path (for solving the tear problem). Next, the PMOS device 421 corresponding to the row N+1 is turned ON. And the aforementioned operation sequence may go on in a row-by-row scanning manner.

FIG. 8 shows a sixth embodiment of the present invention. This embodiment indicates that, in the control method for controlling the LED array billboard 500, the row node of the row N can be electrically connected to the discharging path until or after the row node of the row N+1 starts electrically connecting to the row conduction voltage. That is, as shown in the figure, the NMOS device 422 corresponding to the row N is kept ON until or after the PMOS device 421 corresponding to the row N+1 is turned ON at the time point t.

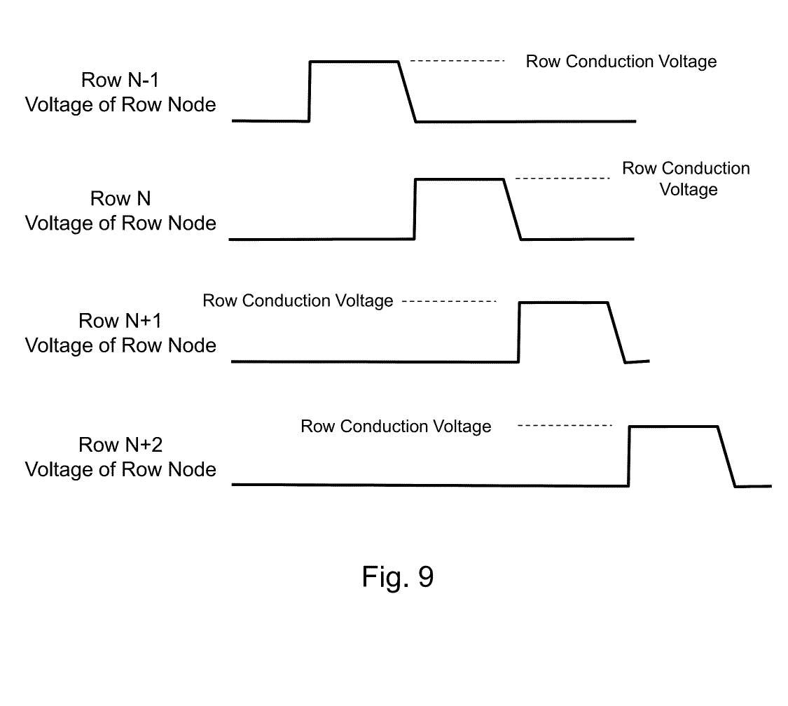

FIG. 9 shows a seventh embodiment of the present invention. This embodiment indicates that, according to the control method of the light emitting device array billboard of the present invention, the step of providing the row conduction voltage to the row node further includes: providing the row conduction voltage to the plural row nodes sequentially. As shown in the figure, the row conduction voltage is provided to the row nodes of the rows N−1, N, N+1, and N+2 sequentially.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits in the shown embodiments, such as a switch or the like, so the term “couple” should include direct and indirect connections. For another example, the light emitting device that is applicable to the present invention is not limited to the LED as shown and described in the embodiments above, but may be any light emitting device with a forward terminal and a reverse terminal. For another example, the PMOS device in the embodiments can be changed to an NMOS device and the NMOS device in the embodiments can be changed to a PMOS device, with corresponding amendments to the circuit and the signals. For another example, the meanings of the high and low levels of a digital signal are interchangeable, with corresponding amendments of the circuits processing the signal. For another example, the light emitting device array does not necessarily have to contain rows each having a same number of light emitting devices and columns each having a same number of light emitting devices, that is, the numbers of the light emitting devices may be different between different rows, or between different columns. For another example, some light emitting devices of the light emitting device array can be arranged not by row and column. For another example, that each unit (at the same coordinates) includes one single light emitting device as shown in the embodiments of the present invention may be changed to plural light emitting devices as one unit. For another example, the row conduction voltage of every row does not necessarily have to be the same; the predetermined low level of every row does not necessarily have to be the same; the column conduction voltage of every row does not necessarily have to be the same; and the predetermined high level of every column does not necessarily have to be the same. Besides, any embodiment or claim of the present invention does not have to include all the advantages and solve all the problems; for example, an embodiment or claim according to the present invention may solve only one or two but not all of the upper ghost image problem, lower ghost image problem, and the tear problem (for example, if the column node is not electrically connected to the predetermined high level Vp, the upper ghost image problem and the tear problem still can be solved, which is still advantageous over the prior art). In view of the foregoing, the spirit of the present invention should cover all such and other modifications and variations, which should be interpreted to fall within the scope of the following claims and their equivalents.

What is claimed is:

1. A light emitting device array billboard, comprising:
a light emitting device array circuit including a plurality of light emitting devices, which are arranged in an array with a plurality of rows and a plurality of columns, wherein forward terminals of the light emitting devices in each row are commonly coupled to a row node, and reverse terminals of the light emitting devices in each column are commonly coupled to a column node;
a plurality of row switch circuits, which are coupled to the row nodes respectively, wherein each row switch circuit determines whether to electrically connect a corresponding row conduction voltage to the corresponding row node or to discharge charges at the corresponding row node through a discharging path according to a row selection signal;
a plurality of column driver circuits, which are coupled to the column nodes respectively, wherein each column driver circuit determines whether or not to electrically connect a corresponding column conduction voltage to the corresponding column node according to a column selection signal; and
a control circuit, which is coupled to the row switch circuits and the column driver circuits, for providing the row selection signal and the column selection signal to the row switch circuits and the column driver circuits respectively.

2. The light emitting device array billboard of claim 1, wherein the row switch circuit includes:
a first switch device, which is coupled to the corresponding row node, for electrically connecting the corresponding row conduction voltage to the corresponding row node according to the row selection signal; and
a second switch device, which is coupled to the corresponding row node, for electrically connecting the corresponding row node to a ground level or a predetermined low level to form the discharging path according to the row selection signal such that the charges are discharged through the discharging path.

3. The light emitting device array billboard of claim 2, wherein the first switch device includes a P-type metal oxide semiconductor (PMOS) device, and the second switch device includes an N-type metal oxide semiconductor (NMOS) device.

4. The light emitting device array billboard of claim 1, wherein the column driver circuit electrically connects a predetermined high level to the corresponding column node when the column driver circuit determines not to electrically connect the column conduction voltage to the corresponding column node, and the column driver circuit includes:
a driver device, which is coupled to the corresponding column node, for generating the corresponding column conduction voltage according to the column selection signal; and
a switch device, which is coupled to the corresponding column node, for electrically connecting the predetermined high level to the corresponding column node according to the column selection signal.

5. The light emitting device array billboard of claim 4, wherein the predetermined high level is higher than the corresponding row conduction voltage minus a conduction voltage of the light emitting device.

6. The light emitting device array billboard of claim 2, wherein the second switch device keeps electrically connecting the corresponding row node to the ground level or the predetermined low level to form the discharge path until or after another row switch circuit electrically connects the corresponding row conduction voltage to another row node.

7. A row switch circuit for use in a light emitting device array billboard, wherein the light emitting device array billboard includes a light emitting device array circuit, a plurality of the row switch circuits, a plurality of column driver circuits, and a control circuit, and wherein the light emitting device array circuit includes a plurality of light emitting devices, which are arranged in an array with a plurality of rows and a plurality of columns, wherein forward terminals of the light emitting devices in each row are commonly coupled to a row node, and reverse terminals of the light emitting devices in each column are commonly coupled to a column node, wherein the row nodes are coupled to the row switch circuits respectively, and the column nodes are coupled to the column driver circuits respectively, and the control circuit generates a row selection signal and a column selection signal for controlling the row switch circuits and the column driver circuits, the row switch circuit comprising:
a first switch device, which is coupled to a corresponding row node, for electrically connecting a corresponding row conduction voltage to the corresponding row node according to the row selection signal; and
a second switch device, which is coupled to the corresponding row node, for discharging charges at the corresponding row node through a discharging path to a ground level or a predetermined low level according to the row selection signal.

8. The row switch circuit of claim 7, wherein the first switch device includes a P-type metal oxide semiconductor (PMOS) device, and the second switch device includes an N-type metal oxide semiconductor (NMOS) device.

9. The row switch circuit of claim 7, wherein the column driver circuit includes:
a driver device, which is coupled to the corresponding column node, for generating a corresponding column conduction voltage at the corresponding column node according to the column selection signal; and
a third switch device, which is coupled to the corresponding column node, for electrically connecting a predetermined high level to the corresponding column node according to the column selection signal.

10. The row switch circuit of claim 9, wherein the predetermined high level is higher than the corresponding row conduction voltage minus a conduction voltage of the light emitting device.

11. The row switch circuit of claim 7, wherein the second switch device keeps electrically connecting the corresponding row node to the ground level or the predetermined low level to form the discharge path until or after another row switch circuit electrically connects another corresponding row conduction voltage to another row node.

12. A control method for controlling a light emitting device array billboard, wherein the light emitting device array billboard has alight emitting device array circuit including a plurality of light emitting devices arranged in an array with a plurality of rows and a plurality of columns, wherein forward terminals of the light emitting devices in each row are commonly coupled to a row node, and reverse terminals of the light emitting devices in each column are commonly coupled to a column node, the control method comprising:
selecting at least one row and at least one column;
electrically connecting a first row conduction voltage to the row node of the selected row;
electrically connecting a column conduction voltage to the column node of the selected column;
conducting a discharging path electrically connected with the row node of the selected row to discharge charges at the row node of the selected row, wherein the discharging path does not go through the light emitting devices; and
stopping conducting the discharging path electrically connected with the row node of the selected row.

13. The control method of claim 12, further comprising: electrically connecting the column node of the selected column to a predetermined high level after electrically connecting the column conduction voltage to the column node of the selected column.

14. The control method of claim 12, wherein the predetermined high level is higher than the first row conduction voltage minus a conduction voltage of the light emitting device.

15. The control method of claim 12, further comprising:
selecting another row after the step of conducting the discharging path electrically connected with the row node of the selected row; and
electrically connecting a second row conduction voltage to the row node of the selected another row, wherein the second conduction voltage is the same or different from the first conduction voltage;
wherein the step of stopping conducting the discharging path electrically connected with the row node of the selected row takes place after the row node of the selected another row is electrically connected to the second row conduction voltage.
